(19) United States
(12) Patent Application Publication
(10) Pub. No.: US 2026/0065417 A1
(43) Pub. Date: Mar. 5, 2026

(54) CONFIGURABLE DOWNSAMPLING FILTERS FOR FOVEATED DOWNSAMPLING

(71) Applicant: APPLE INC., Cupertino, CA (US)

(72) Inventors: Chihsin WU, San Jose, CA (US); David R. POPE, Campbell, CA (US)

(73) Assignee: APPLE INC., Cupertino, CA (US)

(21) Appl. No.: 18/825,934

(22) Filed: Sep. 5, 2024

(51) Int. Cl. G06T 3/4007

(52) U.S. Cl. CPC G06T 3/4007

(57) ABSTRACT

Disclosed herein are a system, method, and computer program product embodiments for performing foveated downsampling based on configurable downsampling filters. For example, a number of downsampling phases between pixels of an image is determined. Based on the number of downsampling phases, a data structure that associates one or more interpolation coefficients with a downsampling filter type is configured. A downsampling factor for downsampling pixel values in a region of the image is determined. Based on the downsampling factor, a downsampling filter type from the data structure is determined. Pixel values in the region of the image are downsampled based on the one or more interpolation coefficients associated with the determined downsampling filter type.

### BACKGROUND

Image data captured by an image sensor or received from other data sources is often processed in an image processing pipeline before further processing or consumption. For example, raw image data may be corrected, filtered, or otherwise modified before being provided to subsequent components such as a video encoder.

Such an image processing pipeline may be structured so that modifications to the captured image data can be performed in an expedient way without consuming other system resources. Although many image processing algorithms may be performed by executing software programs on a central processing unit (CPU), execution of such programs consume significant bandwidth of the CPU and other peripheral resources, as well as increase power consumption. Hence, image processing pipelines are often implemented as a hardware component separate from the CPU and dedicated to perform one or more image processing algorithms.

While utilizing a separate image processing pipeline reduces the computing burden of the CPU, the pipeline still affects the overall compute resource utilization (e.g., memory, storage, power, and/or I/O) of the device in which such a pipeline is included.

### SUMMARY

Various embodiments for performing foveated downsampling are disclosed. In some embodiments, a method includes determining a number of downsampling phases between pixels of an image. The method also includes configuring, based on the number of downsampling phases, a data structure that associates one or more interpolation coefficients with a downsampling filter type. The method further includes determining a downsampling factor for downsampling pixel values in a region of the image. The method also includes determining, based on the downsampling factor, a downsampling filter type from the data structure. The method further includes downsampling pixel values in the region of the image based on the one or more interpolation coefficients associated with the determined downsampling filter type.

In some embodiments, a system includes a memory and at least one processor. The at least one processor is configured to determine a number of downsampling phases between pixels of an image. The at least one processor is also configured to configure, based on the number of downsampling phases, a data structure that associates one or more interpolation coefficients with a downsampling filter type. The at least one processor is further configured to determine a downsampling factor for downsampling pixel values in a region of the image. The at least one processor is also configured to determine, based on the downsampling factor, a downsampling filter type from the data structure. The at least one processor is further configured to downsample pixel values in the region of the image based on the one or more interpolation coefficients associated with the determined downsampling filter type.

In some embodiments, a non-transitory computer readable medium having instructions stored thereon that, when executed by at least one processor, cause the at least one processor to perform operations. The operations include determining a number of downsampling phases between pixels of an image. The operations also includes configuring, based on the number of downsampling phases, a data structure that associates one or more interpolation coefficients with a downsampling filter type. The operations further includes determining a downsampling factor for downsampling pixel values in a region of the image. The operations also includes determining, based on the downsampling factor, a downsampling filter type from the data structure. The operations further includes downsampling pixel values in the region of the image based on the one or more interpolation coefficients associated with the determined downsampling filter type.

### BRIEF DESCRIPTION OF THE DRAWINGS

The accompanying drawings are incorporated herein and form a part of the specification.

FIG. 1 is a diagram of an electronic device, according to some embodiments.

FIG. 2 is a block diagram illustrating components in an electronic device, according to some embodiments.

FIG. 3 is a block diagram illustrating image processing pipelines implemented using an image signal processor, according to some embodiments.

FIG. 4 is a block diagram of a foveated downsampler, according to some embodiments.

FIG. 5 is an example image divided into different regions, according to some embodiments.

FIGS. 6A-6C are diagrams illustrating different downsampling phases, according to some embodiments.

FIGS. 7A-7E are diagrams of data structures configured in accordance with different downsampling phase parameters, according to some embodiments.

FIG. 7F is a diagram of a data structure that includes an identity filter, according to some embodiments.

FIG. 8 is a block diagram of a system for performing foveated downsampling of an image, according to some embodiments.

FIG. 9 is a flowchart of a method for performing foveated downsampling of an image, according to some embodiments.

FIG. 10 is a flowchart of a method for downsampling pixel values, according to some embodiments.

FIG. 11 is a flowchart of a method for bypassing downsampling of a region of an image, according to some embodiments.

FIG. 12 is an example computer system that can be used for implementing some aspects or portion(s) thereof.

In the drawings, like reference numbers generally indicate identical or similar elements. Additionally, generally, the left-most digit(s) of a reference number identifies the drawing in which the reference number first appears.

### DETAILED DESCRIPTION

Foveated rendering is a rendering technique where one region of an image being displayed is rendered at a higher resolution and one or more other regions of the image are rendered at a lower resolution. For instance, one region of the image that a user is directly looking at may be rendered at a higher resolution for visual acceptability, while peripheral regions of the image that the user is not directly looking at may be downsampled and rendered at a lower resolution while still appearing visually acceptable.

Provided herein are a system, apparatus, device, method and/or computer program product embodiments, and/or combinations and sub-combinations thereof, for performing foveated downsampling based on configurable downsampling filters. In some embodiments, a number of downsampling phases between pixels of an image is determined. Based on the number of downsampling phases, a data structure that associates one or more interpolation coefficients with a downsampling filter type is configured. A downsampling factor for downsampling pixel values in a region of the image is determined. Based on the downsampling factor, a downsampling filter type from the data structure is determined. Pixel values in the region of the image are downsampled based on the one or more interpolation coefficients associated with the determined downsampling filter type.

For example, a particular downsampling filter may be utilized to downsample a particular region of an image. A different downsampling filter may be utilized depending on the region and/or the amount of downscaling performed on a particular region. To accommodate the different downsampling filters, one or more data structures (e.g., tables) are utilized to specify different sets of interpolation coefficients for each of the different filters. As the type of downsampling filter utilized may be implementation-specific, such data structures can be relatively large to accommodate all the different implementations.

In accordance with embodiments described herein, a data structure is dynamically generated based on one or more parameters that are indicative of the implementation in which foveated downsampling is utilized. The dynamically-generated data structure indicates the filters and the corresponding sets of interpolation coefficients that are specific to the implementation. This way, a relatively large set of data structures (which can include unused filters and coefficients) is not required to be maintained. Accordingly, the embodiments described herein conserve various compute resources (e.g., memory, storage, processing cycles, and input/output (I/O) cycles).

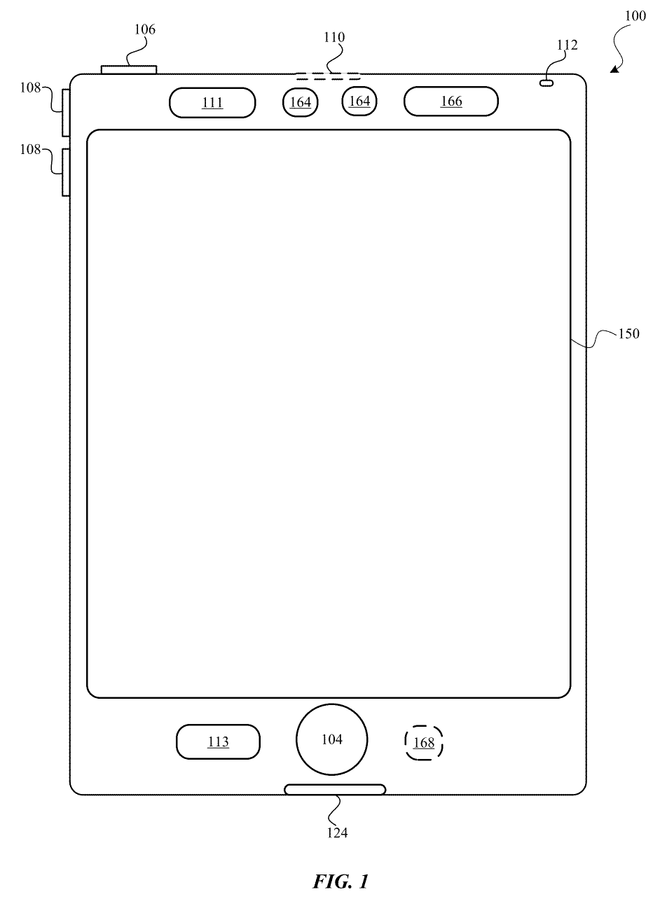

Embodiments of electronic devices, user interfaces for such devices, and associated processes for using such devices are described herein. In some embodiments, the device is a portable communications device, such as a mobile telephone, that also includes other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, virtual, augmented, or mixed reality headsets, laptops or tablet computers, are optionally used. An exemplary embodiment of a headset includes the Apple Vision Pro® from Apple Inc. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 includes various components including a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensor 164. Each type may include more than one image sensor 164. For example, one type of image sensor 164 may be a camera and another type of image sensor 164 may be infrared sensor that may be used for face recognition. Additionally or alternatively, image sensors 164 may be associated with different lens configuration. For example, device 100 may include rear image sensors, one with a wide-angle lens and another with as a telephoto lens. Device 100 may include components not shown in FIG. 1, such as an ambient light sensor, a dot projector, and a flood illuminator.

Device 100 is only one example of an electronic device, and device 100 may have more or fewer components than listed above, some of which may be combined into a component or have a different configuration or arrangement. The various components of device 100 listed above are embodied in hardware, software, firmware, or a combination thereof, including one or more signal processing and/or application specific integrated circuits (ASICs). While the components in FIG. 1 are shown as generally located on the same side as the touch screen 150, one or more components may also be located on an opposite side of device 100. For example, the front side of device 100 may include an infrared image sensor 164 for face recognition and another image sensor 164 as the front camera of device 100. The back side of device 100 may also include additional image sensors 164 as the rear cameras of device 100.

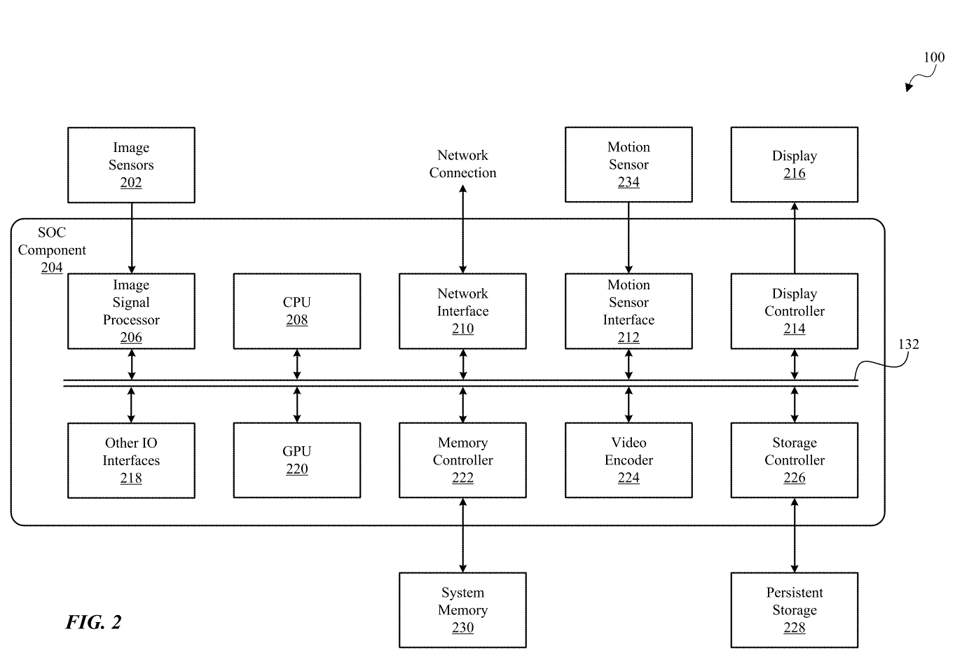

FIG. 2 is a block diagram illustrating components in device 100, according to some embodiments. Device 100 may perform various operations including image processing. For this and other purposes, device 100 may include image sensors 202, a system-on-a chip (SOC) component 204, a system memory 230, a persistent storage (e.g., flash memory) 228, an orientation sensor 234, and a display 216. The components as illustrated in FIG. 2 are merely illustrative. For example, device 100 may include other components (e.g., speaker or microphone) that are not illustrated in FIG. 2. Further, some components (e.g., orientation sensor 234) may be omitted from device 100.

Image sensors 202 are components for capturing image data. Each of image sensors 202 may be embodied, for example, as a complementary metal-oxide-semiconductor (CMOS) active-pixel sensor, a camera, video camera, or other devices. Image sensors 202 generate raw image data that is sent to SOC component 204 for further processing. In some embodiments, the image data processed by SOC component 204 is displayed on display 216, stored in system memory 230 and/or persistent storage 228, or sent to a remote computing device via a network connection. The raw image data generated by image sensors 202 may be in a Bayer color filter array (CFA) pattern (hereinafter also referred to as “Bayer pattern”) or a Quad Bayer pattern (hereinafter also referred to as a “Quadra pattern”). Image sensor 202 may also include optical and mechanical components that assist image sensing components (e.g., pixels) to capture images. The optical and mechanical components may include an aperture, a lens system, and an actuator that controls the focal length of image sensor 202.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is a component for displaying images as generated by SOC component 204. Display 216 may include, for example, a liquid crystal display (LCD) device or an organic light emitting diode (OLED) device. Based on data received from SOC component 204, display 116 may display various images, such as menus, selected operating parameters, images captured by image sensors 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory, or other non-volatile random access memory devices.

SOC component 204 is embodied as one or more integrated circuit (IC) chips and performs various data processing processes. SOC component 204 may include image signal processor (ISP) 206, a central processor unit (CPU) 208, a network interface 210, a motion sensor interface 212, a display controller 214, a graphics processor (GPU) 220, a memory controller 222, a video encoder 224, a storage controller 226, and various other input/output (I/O) interfaces 218, and bus 232 connecting these subcomponents. SOC component 204 may include more or fewer subcomponents than those shown in FIG. 2.

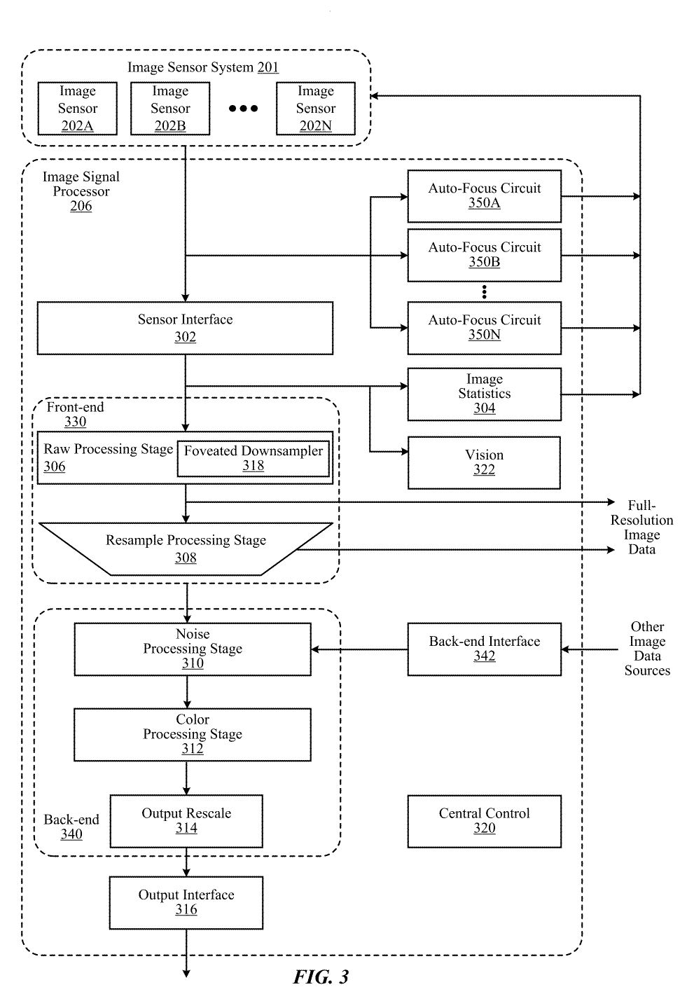

ISP 206 is hardware that performs various stages of an image processing pipeline. In some embodiments, ISP 206 may receive raw image data from image sensors 202 and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations, as described below in detail with reference to FIG. 3.

CPU 208 may be embodied using any suitable instruction set architecture and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing operations on graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

I/O interfaces 218 are hardware, software, firmware or combinations thereof for interfacing with various input/output components in device 100. I/O components may include devices, such as keypads, buttons, audio devices, and sensors (e.g., a global positioning system). I/O interfaces 218 process data for sending data to such I/O components or process data received from such I/O components.

Network interface 210 is a subcomponent that enables data to be exchanged among devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, Local Area Networks (LANs) (e.g., an Ethernet or corporate network) and Wide Area Networks (WANs). The image data received via network interface 210 may undergo image processing processes by ISP 206.

Motion sensor interface 212 is circuitry for interfacing with motion sensor 234. Motion sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220, or other subcomponents of SOC component 204. Memory controller 222 may also write data to system memory 230 received from various subcomponents of SOC component 204.

Video encoder 224 is hardware, software, firmware, or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on ISP 206, CPU 208, or GPU 220. Such software components may be stored in system memory 230, persistent storage 228, or another device communicating with device 100 via network interface 210.

Image data or video data may flow through various data paths within SOC component 204. In one example, raw image data may be generated from image sensors 202 and processed by ISP 206 and then sent to system memory 230 via bus 232 and memory controller 222. After the image data is stored in system memory 230, it may be accessed by video encoder 224 for encoding or by display 116 for displaying via bus 232.

In another example, image data is received from sources other than image sensors 202. For example, video data may be streamed, downloaded, or otherwise communicated to SOC component 204 via wired or wireless network. The image data may be received via network interface 210 and written to system memory 230 via memory controller 222. The image data may then be obtained by ISP 206 from system memory 230 and processed through one or more image processing pipeline stages, as described below in detail with reference to FIG. 3. The image data may then be returned to system memory 230 or be sent to video encoder 224, display controller 214 (e.g., for display on display 216), or storage controller 226 for storage at persistent storage 228.

FIG. 3 is a block diagram illustrating image processing pipelines implemented using ISP 206, according to some embodiments. In some embodiments, ISP 206 is coupled to an image sensor system 201 that includes one or more image sensors 202A through 202N (hereinafter collectively referred to as “image sensors 202” or also referred individually as “image sensor 202”) to receive raw image data. Image sensor system 201 may include one or more sub-systems that control image sensors 202 individually. In some embodiments, each image sensor 202 may operate independently while, in other cases, image sensors 202 may share one or more components. For example, two or more image sensors 202 may share the same circuit board that controls the mechanical components of the image sensors (e.g., actuators that change the focal lengths of each image sensor). The image sensing components of image sensor 202 may include different types of image sensing components that may provide raw image data in different forms to ISP 206. For example, the image sensing components may include multiple focus pixels that are used for auto-focusing and multiple image pixels that are used for capturing images. In some embodiments, the image sensing pixels may be used for both auto-focusing and image capturing purposes.

ISP 206 implements an image processing pipeline which may include a set of stages that process image information from creation, capture, or receipt to output. ISP 206 may include a sensor interface 302, a central control 320, front-end pipeline stages 330, back-end pipeline stages 340, an image statistics module 304, a vision module 322, a back-end interface 342, an output interface 316, and auto-focus circuits 350A through 350N (hereinafter collectively referred to as “auto-focus circuits 350” or referred individually as “auto-focus circuits 350”). ISP 206 may include other components not illustrated in FIG. 3 or may omit one or more components illustrated in FIG. 3.

In some embodiments, different components of ISP 206 process image data at different rates. In some embodiments, front-end pipeline stages 330 (e.g., raw processing stage 306 and resample processing stage 308) may process image data at an initial data rate. Thus, the various different techniques, adjustments, modifications, or other processing operations may be performed by these front-end pipeline stages 330 at the initial data rate. For example, if front-end pipeline stages 330 process two pixels per clock cycle, then raw processing stage 306 operations (e.g., black level compensation, highlight recovery, and defective pixel correction) may process two pixels of image data at a time. In contrast, one or more back-end pipeline stages 340 may process image data at a different data rate less than the initial data rate. For example, in some embodiments, back-end pipeline stages 340 (e.g., noise processing stage 310, color processing stage 312, and output rescale 314) may be processed at a reduced data rate (e.g., one pixel per clock cycle).

Raw image data captured by image sensors 202 may be transmitted to different components of ISP 206 in different manners. In some embodiments, raw image data corresponding to the focus pixels may be sent to auto-focus circuits 350 while raw image data corresponding to the image pixels may be sent to sensor interface 302. In some embodiments, raw image data corresponding to both types of pixels may simultaneously be sent to both auto-focus circuits 350 and sensor interface 302.

Auto-focus circuits 350 may include a hardware circuit that analyzes raw image data to determine an appropriate focal length of each image sensor 202. In some embodiments, the raw image data may include data that is transmitted from image sensing pixels that perform image focusing operations. In some embodiments, raw image data from image capture pixels may also be used for auto-focusing purpose. Auto-focus circuit 350 may perform various image processing operations to generate data that determines the appropriate focal length. The image processing operations may include cropping, binning, image compensation, and scaling to generate data that is used for auto-focusing purpose, etc. The auto-focusing data generated by auto-focus circuits 350 may be fed back to image sensor system 201 to control the focal lengths of image sensors 202. For example, image sensor 202 may include a control circuit that analyzes the auto-focusing data to determine a command signal that is sent to an actuator associated with the lens system of image sensor 202 to change the focal length of image sensor 202. The data generated by auto-focus circuits 350 may also be sent to other components of ISP 206 for other image processing purposes. For example, some of the data may be sent to image statistics module 304 to determine information regarding auto-exposure.

Auto-focus circuits 350 may be individual circuits that are separate from other components, such as image statistics module 304, sensor interface 302, front-end 330, and back-end 340. This allows ISP 206 to perform auto-focusing analysis independent of other image processing pipelines. For example, ISP 206 may analyze raw image data from image sensor 202A to adjust the focal length of image sensor 202A using auto-focus circuit 350A while performing downstream image processing of the image data from image sensor 202B simultaneously. In some embodiments, the number of auto-focus circuits 350 may correspond to the number of image sensors 202. In other words, each image sensor 202 may have a corresponding auto-focus circuit that is dedicated to the auto-focusing of image sensor 202. Device 100 may perform auto focusing for different image sensors 202 even if one or more image sensors 202 are not in active use. This allows a seamless transition between two image sensors 202 when device 100 switches from one image sensor 202 to another. For example, device 100 may include a wide-angle camera and a telephoto camera as a dual back camera system for photo and image processing. Device 100 may display images captured by one of the dual cameras and may switch between the two cameras from time to time. The displayed images may seamless transition from image data captured by one image sensor 202 to image data captured by another image sensor 202 without waiting for second image sensor 202 to adjust its focal length because two or more auto-focus circuits 350 may continuously provide auto-focus data to image sensor system 201.

Raw image data captured by different image sensors 202 may also be transmitted to sensor interface 302. Sensor interface 302 receives raw image data from image sensors 202 and processes the raw image data into an image data processable by other stages in the pipeline. Sensor interface 302 may perform various preprocessing operations, such as image cropping, binning or scaling to reduce image data size. In some embodiments, pixels are sent from image sensors 202 to sensor interface 302 in raster order (e.g., horizontally, line by line). The subsequent processes in the pipeline may also be performed in raster order and the result may also be output in raster order. Although only a single image sensor system 201 and a single sensor interface 302 are illustrated in FIG. 3, when more than one image sensor system is provided by device 100, a corresponding number of sensor interfaces may be provided in ISP 206 to process raw image data from each image sensor system.

Front-end pipeline stages 330 process image data in raw or full-color domains. Front-end pipeline stages 330 may include raw processing stage 306 and resample processing stage 308. A raw image data may be in a Bayer raw image format or a Quadra raw image format, for example. In such raw image format, pixel data with values specific to a particular color (instead of all colors) is provided in each pixel. In an image capturing sensor, image data can be provided in the Bayer or Quadra pattern. Raw processing stage 306 may process image data in the Bayer or Quadra raw image format.

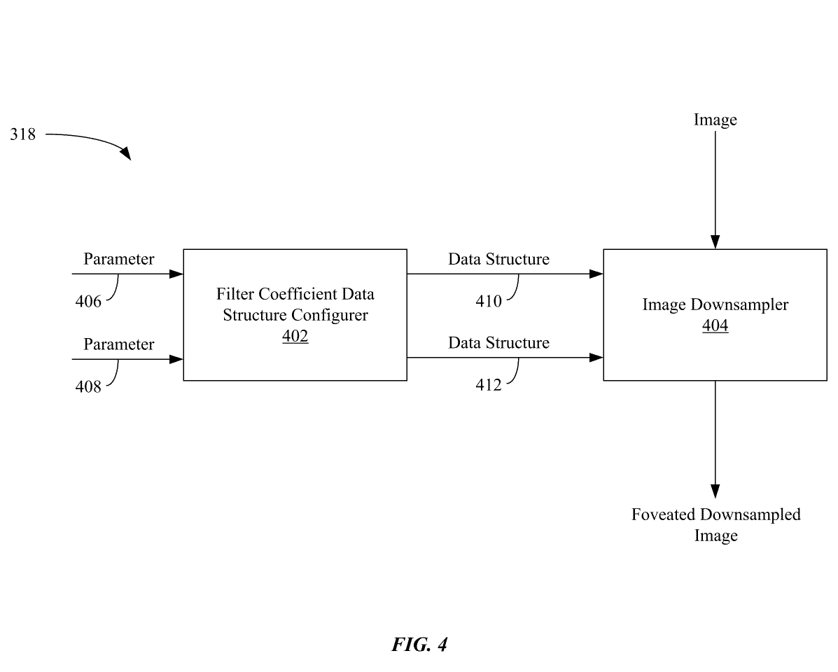

The operations performed by raw processing stage 306 include sensor linearization, black level compensation, fixed pattern noise reduction, defective pixel correction, raw noise filtering, lens shading correction, white balance gain, highlight recovery, and downsampling. Sensor linearization refers to mapping non-linear image data to linear space for other processing. Black level compensation refers to providing digital gain, offset and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighboring pixels that are similar in brightness. Highlight recovery refers to estimating pixel values for those pixels that are clipped (or nearly clipped) from other channels. Lens shading correction refers to applying a gain per pixel to compensate for a dropoff in intensity roughly proportional to a distance from a lens optical center. White balance gain refers to providing digital gains for white balance, offset and clip independently for all color components (e.g., Gr, R, B, Gb in the Bayer pattern). Downsampling refers to reducing the resolution of an image (or certain regions thereof) by discarding pixels. A foveated downsampler 318 in raw processing stage 306 may perform foveated downsampling on image(s) captured by image sensors 202. Details about a structure and operation of foveated downsampler 318 are provided in relation to FIGS. 4-11.

Components of ISP 206 may convert raw image data into image data in full-color domain and thus raw processing stage 306 may process image data in the full-color domain in addition to or instead of raw image data

Resample processing stage 308 performs various operations to convert, resample, or scale image data received from raw processing stage 306. Operations performed by resample processing stage 308 may include a demosaic operation, a per-pixel color correction operation, a Gamma mapping operation, a color space conversion, and a downscaling or sub-band splitting. The demosaic operation refers to converting or interpolating missing color samples from raw image data (e.g., in the Bayer pattern) to output image data into a full-color domain. The demosaic operation may include low pass directional filtering on the interpolated samples to obtain full-color pixels. The per-pixel color correction operation refers to a process of performing color correction on a per-pixel basis using information about relative noise standard deviations of each color channel to correct color without amplifying noise in the image data. The Gamma mapping operation refers to converting image data from input image data values to output data values to perform gamma correction. For the purpose of the Gamma mapping operation, lookup tables (or other structures that index pixel values to another value) for different color components or channels of each pixel (e.g., a separate lookup table for R, G, and B color components) may be used. The color space conversion refers to converting color space of an input image data into a different format. In some embodiments, resample processing stage 308 converts RGB format into YCbCr format for further processing.

Central control module 320 may control and coordinate overall operation of other components in ISP 206. Central control module 320 performs operations including monitoring various operating parameters (e.g., logging clock cycles, memory latency, quality of service, and state information), updating or managing control parameters for other components of ISP 206, and interfacing with sensor interface 302 to control the starting and stopping of other components of ISP 206. For example, central control module 320 may update programmable parameters for other components in ISP 206 while the other components are in an idle state. After updating the programmable parameters, central control module 320 may place these components of ISP 206 into a run state to perform one or more operations or tasks. Central control module 320 may also instruct other components of ISP 206 to store image data (e.g., by writing to system memory 230 in FIG. 2) before, during, or after resample processing stage 308. In this way, full-resolution image data in raw or full-color domain format may be stored in addition to or instead of processing the image data output from resample processing stage 308 through backend pipeline stages 340.

Image statistics module 304 performs various operations to collect statistic information associated with the image data. The operations for collecting statistics information may include sensor linearization, replacing patterned defective pixels, sub-sampling raw image data, detection and replacement of non-patterned defective pixels, black level compensation, lens shading correction, and inverse black level compensation. After performing one or more of such operations, statistics information (e.g., 3A statistics (auto-focus, auto white balance (AWB), auto exposure (AE), histograms (e.g., 2D color or component), and any other image data information) may be collected or tracked. In some embodiments, certain pixels’ values or areas of pixel values may be excluded from collections of certain statistics data when preceding operations identify clipped pixels. Although only a single statistics module 304 is illustrated in FIG. 3, multiple image statistics modules may be included in ISP 206. For example, each image sensor 202 may correspond to an individual image statistics module 304. In some embodiments, each statistic module may be programmed by central control module 320 to collect different information for the same or different image data.

Vision module 322 performs various operations to facilitate computer vision operations at CPU 208, such as facial detection in image data. Vision module 322 may perform various operations including pre-processing, global tone-mapping and Gamma correction, vision noise filtering, resizing, keypoint detection, generation of histogram-of-orientation gradients (HOG), and normalized cross correlation (NCC). The pre-processing may include subsampling or binning operation and computation of luminance if the input image data is not in YCrCb format. Global mapping and Gamma correction can be performed on the pre-processed data on luminance image. Vision noise filtering is performed to remove pixel defects and reduce noise present in the image data, and thereby improve the quality and performance of subsequent computer vision algorithms. Such vision noise filtering may include detecting and fixing dots or defective pixels and performing bilateral filtering to reduce noise by averaging neighboring pixels of similar brightness. Various vision algorithms use images of different sizes and scales. Resizing of an image is performed, for example, by binning or linear interpolation operation. Keypoints are locations within an image that are surrounded by image patches well suited to matching in other images of the same scene or object. Such keypoints are useful in image alignment, computing camera pose, and object tracking. Keypoint detection refers to the process of identifying such keypoints in an image. HOG provides descriptions of image patches for tasks in image analysis and computer vision. HOG can be generated, for example, by (i) computing horizontal and vertical gradients using a difference filter, (ii) computing gradient orientations and magnitudes from the horizontal and vertical gradients, and (iii) binning the gradient orientations. NCC is the process of computing spatial cross-correlation between a patch of image and a kernel.

Back-end interface 342 receives image data from other image sources than image sensor 102 and forwards the image data to other components of ISP 206 for processing. For example, image data may be received over a network connection and be stored in system memory 230. Back-end interface 342 retrieves the image data stored in system memory 230 and provides the image data to back-end pipeline stages 340 for processing. Back-end interface 342 may convert the retrieved image data to a format that can be utilized by back-end processing stages 340. For instance, back-end interface 342 may convert RGB, YCbCr 4:2:0, or YCbCr 4:2:2 formatted image data into YCbCr 4:4:4 color format.

Back-end pipeline stages 340 processes image data according to a particular full-color format (e.g., YCbCr 4:4:4 or RGB). In some embodiments, components of the back-end pipeline stages 340 may convert image data to a particular full-color format before further processing. Back-end pipeline stages 340 may include noise processing stage 310 and color processing stage 312. Back-end pipeline stages 340 may include other stages not illustrated in FIG. 3.

Noise processing stage 310 performs various operations to reduce noise in the image data. The operations performed by noise processing stage 310 include color space conversion, gamma/de-gamma mapping, temporal filtering, noise filtering, luma sharpening, and chroma noise reduction. The color space conversion may convert an image data from one color space format to another color space format (e.g., RGB format converted to YCbCr format). Gamma/de-gamma operation converts image data from input image data values to output data values to perform gamma correction or reverse gamma correction. Temporal filtering filters noise using a previously-filtered image frame to reduce noise. For example, pixel values of a prior image frame are combined with pixel values of a current image frame. Noise filtering may include, for example, spatial noise filtering. Luma sharpening may sharpen luma values of pixel data while chroma suppression may attenuate chroma to gray (e.g., no color). In some embodiments, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In some embodiments, spatial noise filtering may not be included as part of the temporal loop for temporal filtering (e.g., the spatial noise filter may be applied to an image frame after it is stored as a reference image frame and thus the reference frame is not spatially filtered).

Color processing stage 312 may perform various operations associated with adjusting color information in the image data. The operations performed in color processing stage 312 include local tone mapping, gain/offset/clip, color correction, three-dimensional color lookup, gamma conversion, and color space conversion. Local tone mapping refers to spatially varying local tone curves in order to provide more control when rendering an image. For instance, a two-dimensional grid of tone curves (which may be programmed by central control module 320) may be bilinearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to image data. 3D color lookup may utilize a three-dimensional array of color component output values (e.g., R, G, B) to perform advanced tone mapping, color space conversions, and other color transforms. Gamma conversion may be performed, for example, by mapping input image data values to output data values in order to perform gamma correction, tone mapping, or histogram matching. Color space conversion may be implemented to convert image data from one color space to another (e.g., RGB to YCbCr). Other processing techniques may also be performed as part of color processing stage 312 to perform other imaging operations, including black and white conversion, sepia tone conversion, negative conversion, or solarize conversion.

Output rescale module 314 may resample, transform, and correct distortion on the fly as ISP 206 processes image data. Output rescale module 314 may compute a fractional input coordinate for each pixel and use this fractional coordinate to interpolate an output pixel via a polyphase resampling filter. A fractional input coordinate may be produced from a variety of possible transforms of an output coordinate, such as resizing or cropping an image (e.g., via a simple horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center in order to index an interpolated radial gain table, and applying a radial perturbance to a coordinate to account for a radial lens distortion).

Output rescale module 314 may apply transforms to image data as it is processed at output rescale module 314. Output rescale module 314 may include horizontal and vertical scaling components. The vertical portion of the design may implement a series of image data line buffers to hold the “support” needed by the vertical filter. As ISP 206 may be a streaming device, it may be that only the lines of image data in a finite-length sliding window of lines are available for the filter to use. Once a line has been discarded to make room for a new incoming line, the line may be unavailable. Output rescale module 314 may statistically monitor computed input Y coordinates over previous lines and use it to compute an optimal set of lines to hold in the vertical support window. For each subsequent line, output rescale module may automatically generate a guess as to the center of the vertical support window. In some embodiments, the output rescale module 314 may implement a table of piecewise perspective transforms encoded as digital difference analyzer (DDA) steppers to perform a per-pixel perspective transformation between an input image data and output image data in order to correct artifacts and motion caused by sensor motion during the capture of the image frame. Output rescale may provide image data via output interface 316 to various other components of device 100, as discussed above with reference to FIGS. 1 and 2.

In some embodiments, the functionally of components 302 through 350 may be performed in a different order than the order implied by the order of these functional units in the image processing pipeline illustrated in FIG. 3 or may be performed by different functional components than those illustrated in FIG. 3. Moreover, the various components as described in FIG. 3 may be embodied in various combinations of hardware, firmware, or software.

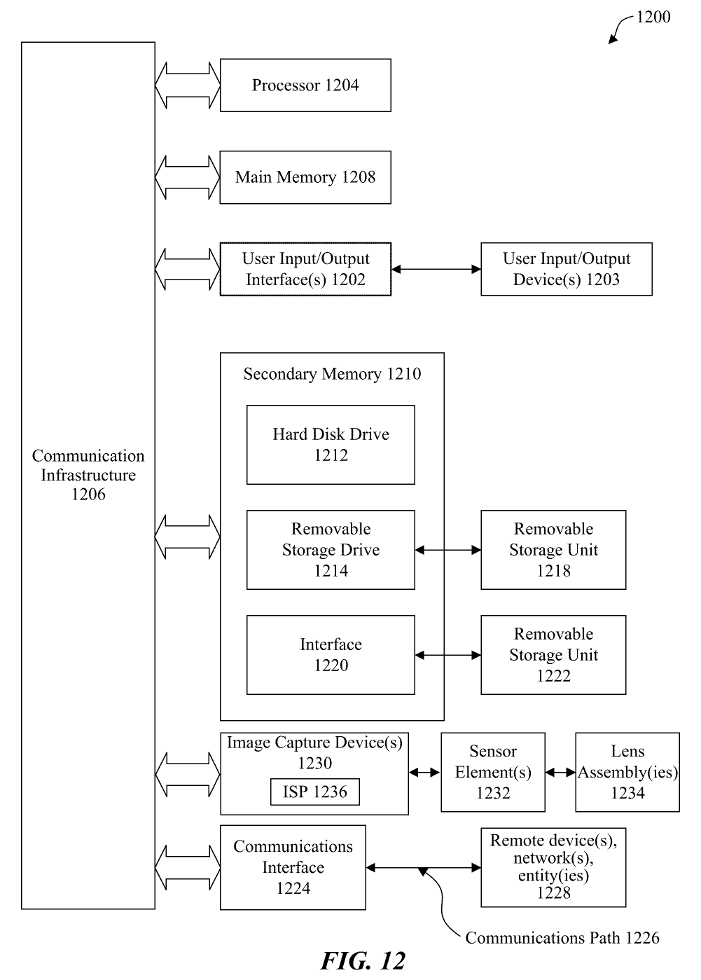

FIG. 4 is a block diagram of foveated downsampler 318, according to some embodiments. As shown in FIG. 4, foveated downsampler 318 includes a filter coefficient data structure configurer 402 and an image downsampler 404. Filter coefficient data structure configurer 402 and image downsampler 404 may be implemented by processing logic that can include hardware (e.g., circuitry, dedicated logic, programmable logic, and/or microcode), software (e.g., instructions executing on a processing device), or a combination thereof. In some embodiments, each of filter coefficient data structure configurer 402 and image downsampler 404 is implemented in one or more software processes executing on one or more processor-based computer systems, such as computer system 1200 as described below in reference to FIG. 12.

Filter coefficient data structure configurer 402 may be configured to obtain a first parameter 406 and a second parameter 408. First parameter 406 may indicate a number of possible downsampling phases in a first direction of an image. Second parameter 408 may indicate a number of possible downsampling phases in a second direction of the image. In some embodiments, the second direction is orthogonal to the first direction (e.g., the first direction is a vertical direction, and the second direction is a horizontal direction).

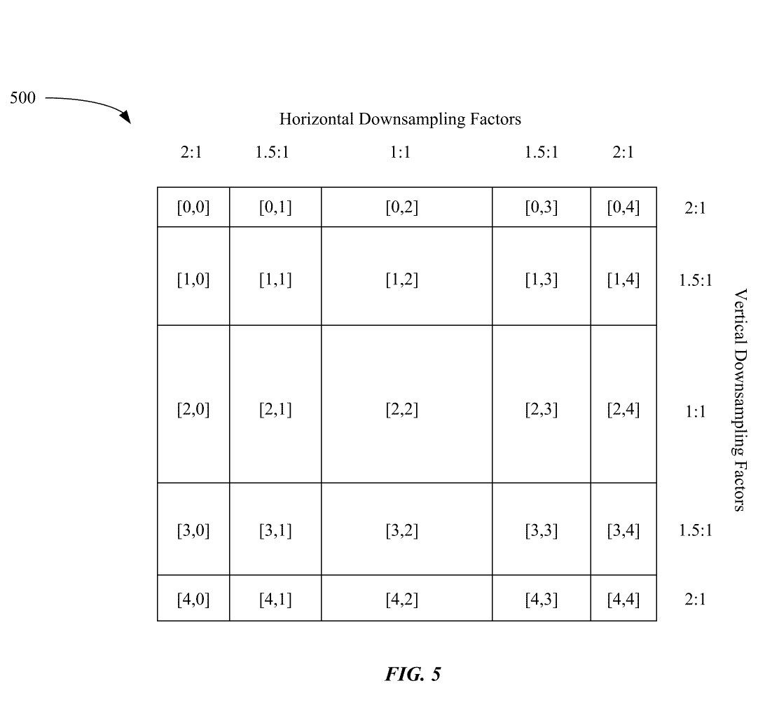

The number of possible downsampling phases for a particular direction may be based on the downsampling factors utilized for downsampling different regions of an image. For instance, to generate a foveated downsampled image, different regions of an image may be downsampled in accordance with different downsampling factors in both the first and second directions. For example, FIG. 5 is an example image 500 divided into different regions, according to some embodiments. As shown in image 500, each region is associated with a particular downsampling factor in each of the first and second directions. Region [2,2] represents a region that a user is focused (e.g., a focal or fixation point). Accordingly, downsampling is not performed for this region (e.g., the downsampling factors in both the horizontal and vertical directions are 1:1) to preserve the details of this region of image 500. The level of downsampling increases the further a region is from the focal point. For example, region [1,1] is downsampled in both the horizontal and vertical directions in accordance with a 1.5:1 downsampling factor. In another example, region [0,0] is downsampled in the horizontal and vertical directions in accordance with a 2:1 downsampling factor. It is noted that a particular region may be associated with different horizontal and vertical downsampling factors. For instance, region [2,1] may be downsampled in the horizontal direction in accordance with a 1.5:1 downsampling factor and may be downsampled in the vertical direction in accordance with a 1:1 downsampling factor.

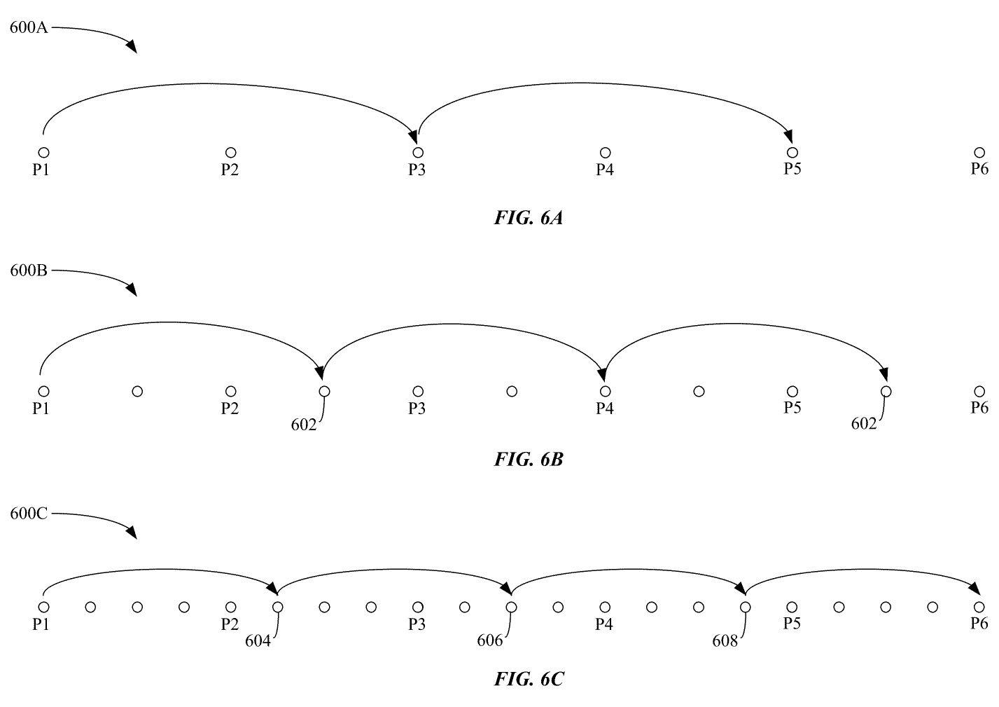

The number of possible downsampling phases may be based on the downsampling factor that results in the most number of downsampling phases. Downsampling phases may correspond to possible downsampled locations (or landings) in a particular direction between any two adjacent pixels. Downsampled locations may be either in-phase or out-of-phase. An in-phase location may correspond to a downsampled location in which a pixel is located. An out-of-phase location may correspond to a downsampled location in which a pixel is not located (e.g., a location or region between two adjacent pixels). For instance, FIGS. 6A-6C are diagrams illustrating different downsampling phases in a second direction (e.g., a horizontal direction), according to some embodiments. In accordance with FIG. 6A, a 2:1 downsampling factor is utilized to downsample a portion of an image including, in part, pixels P1-P6. As shown in FIG. 6A, every other pixel (e.g., P3, P5, etc.) is sampled. Accordingly, the downsampled locations are in-phase (e.g., the sampled location lands on a pixel). As such, the number of phases resulting from 2:1 downsampling is 1. In accordance with FIG. 6B, a 1.5:1 downsampling factor is utilized to downsample a portion of the image. As shown in FIG. 6B, the downsampling locations are either in a location centered between two adjacent pixels (e.g., locations 602) or are in-phase. As such, the number of phases resulting from 1.5:1 downsampling is 2 (one in-phase location and one out-of-phase location). In accordance with FIG. 6C, a 1.25:1 downsampling factor is utilized to downsample a portion of the image. As shown in FIG. 6C, the out-of-phase downsampling locations between any two adjacent pixels may be in one of three locations 604, 606, or 608. Every fourth downsampling operation results in an in-phase downsampling location (e.g., P6). As such, the number of phases resulting from 1.25:1 downsampling is 4 (three out-of-phase locations and one in-phase location).

Accordingly, in a scenario in which a first region of an image is downsampled in the horizontal direction in accordance with a 1.5:1 downsampling factor and a second region of an image is downsampled in the horizontal direction in accordance with a 1.25:1 downsampling factor, the maximum possible number of downsampling phases in the horizontal direction for the image is 4 (attributable to the 1.25:1 downsampling factor). Such a number may be indicated by first parameter 406. Similarly, second parameter 408 may indicate the maximum possible number of downsampling phases in the vertical direction for the image. The values of first parameter 406 and second parameter 408 may be predetermined, stored, and/or retrieved from a configuration register of a device in which foveated downsampler 318 is included.

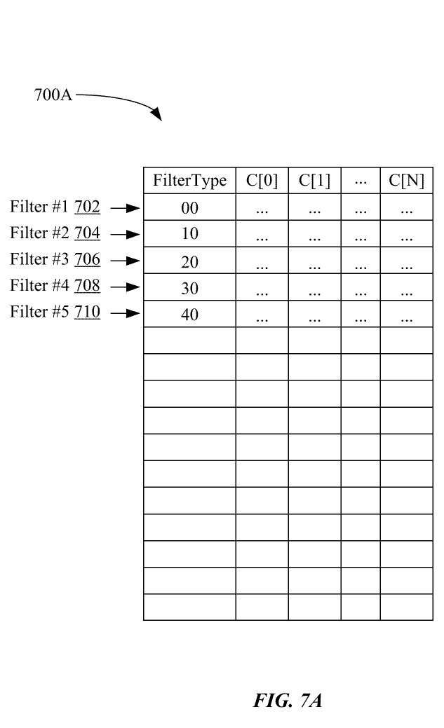

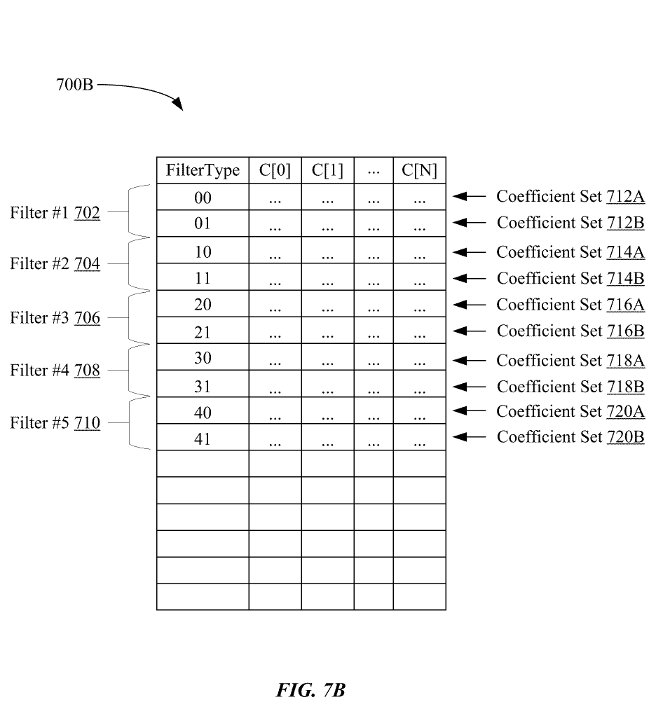

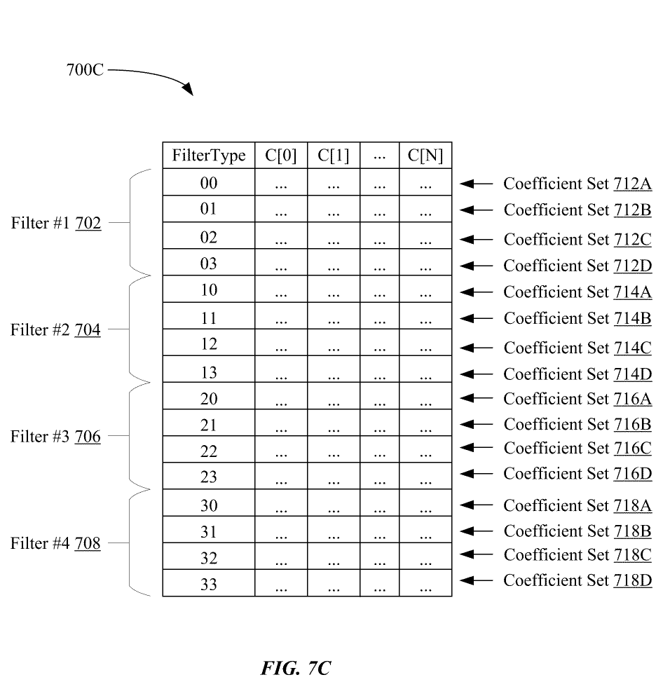

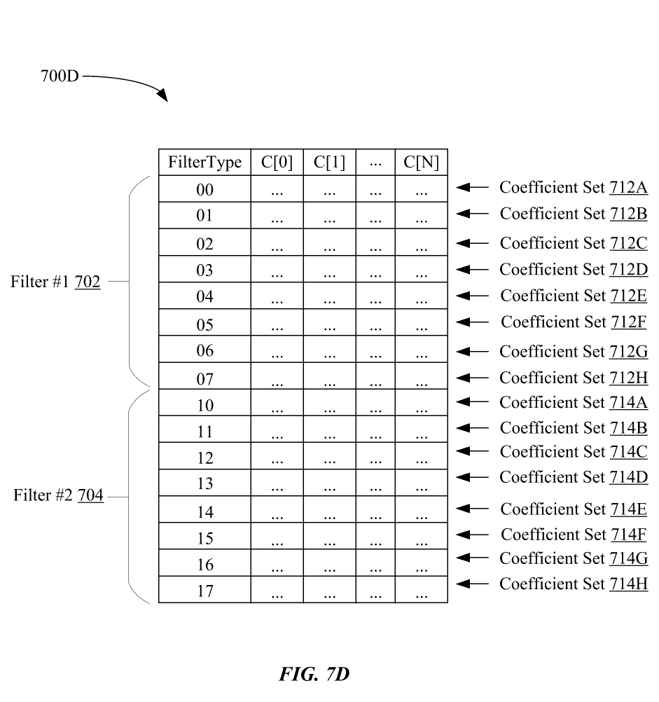

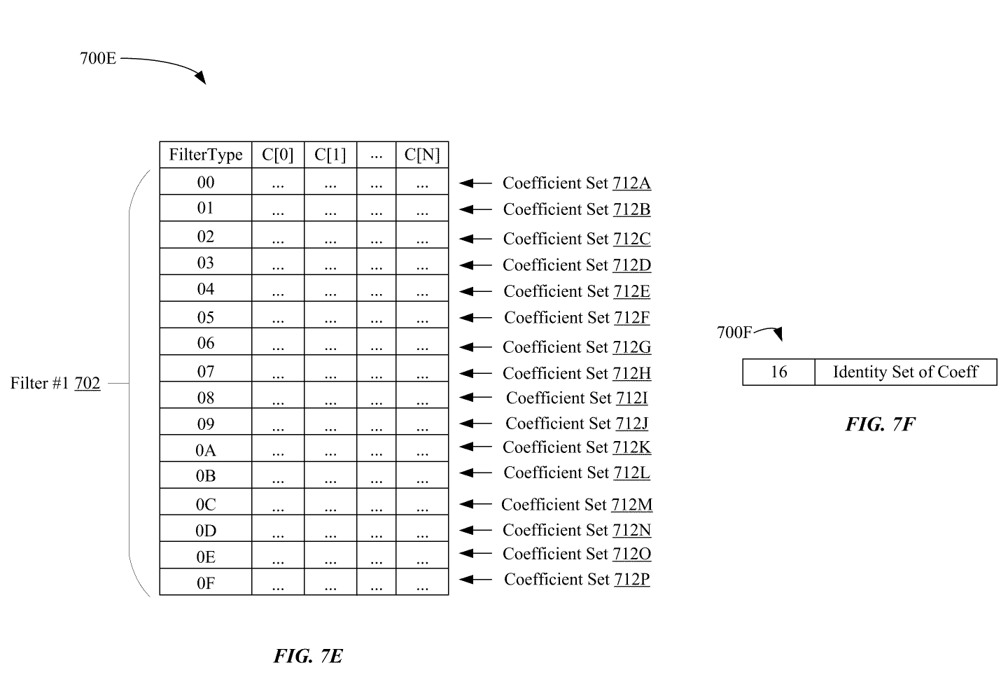

Filter coefficient data structure configurer 402 may determine a number of downsampling filter types that can be included in first data structure 410 based on the maximum size supported for first data structure 410 and the number of vertical downsampling phases indicated by first parameter 406. Similarly, filter coefficient data structure configurer 402 may determine a number of downsampling filter types that can be included in second data structure 414 based on the maximum size supported for second data structure 414 and the number of horizontal downsampling phases indicated by second parameter 408. For instance, FIGS. 7A-7E are diagrams illustrating data structures 700A-700E configured in accordance with different maximum numbers of downsampling phases, according to some embodiments. In the examples shown in FIGS. 7A-7E, data structures 700A-700E are look-up tables having a maximum size of 16 entries. Data structures 700A-700E are examples of data structures 410 or 412.

FIGS. 7A-7E will be described with reference to first parameter 406. However, it is noted that data structures 700A-700E may be configured in a similar manner based on second parameter 408. Data structure 700A is configured in accordance with first parameter 406 indicating that the maximum possible number of downsampling phases is equal to 1 (e.g., the downsampling phase is in-phase). In this example, each entry in data structure 700A may include a different downsampling filter type. Accordingly, up to 16 different downsampling filter types may be included by data structure 700A. It is noted that only 5 different downsampling filtering types are shown for brevity (shown as filter 1702, filter 2704, filter 3706, filter 4708, and filter 5710). Filter coefficient data structure configurer 402 may also associate a set of interpolation coefficients C[0] to C[N] with each filter type, where N is any positive integer.

Data structure 700B is configured in accordance with first parameter 406 indicating that the maximum possible number of downsampling phases is equal to 2 (e.g., one downsampling phase is in-phase, and the other downsampling phase is out-of-phase). In this example, up to 8 different downsampling filter types may be included in data structure 700B, and each of the 8 downsampling filter types may be associated with two different sets of interpolation coefficients (respectively shown as coefficient sets 712A and 712B, coefficient sets 714A and 714B, coefficient sets 716A and 716B, coefficient sets 718A and 718B, and coefficient sets 720A and 720B). It is noted that only 5 different downsampling filter types are shown for brevity (shown as filter 1702, filter 2704, filter 3706, filter 4708, and filter 5710). Each set of the different sets of interpolation coefficients may indicate the level of contribution of each of the pixels adjacent to the downsampling location for generating an interpolated pixel value. For instance, the first set of interpolation coefficients for a particular filter type may cause a first pixel adjacent to the downsampling location (e.g., the pixel left of the downsampling location) to contribute more towards the interpolated pixel value than a second pixel adjacent to the downsampling location (e.g., the pixel right of the downsampling location). The second set of interpolation coefficients may cause the second pixel adjacent to the downsampling location (e.g., the pixel right of the downsampling location) to contribute more towards the interpolated pixel value than the first pixel adjacent to the downsampling location (e.g., the pixel left of the downsampling location). The level of contribution may be indicated by weighting each set of interpolation coefficients (e.g., one or more interpolation coefficients are associated with a respective weight value). The level of contribution of each of the first pixel value and the second pixel value towards the interpolated pixel value is based on the weight value associated with the interpolation coefficient(s) in the set of interpolation coefficients. It is noted that only 5 different downsampling filtering types are shown for brevity (shown as filter 1702, filter 2704, filter 3706, filter 4708, and filter 5710).

Data structure 700C is configured in accordance with first parameter 406 indicating that the maximum possible number of downsampling phases is equal to 4 (e.g., one downsampling phase is in-phase, and the other three downsampling phases are out-of-phase). In this example, up to 4 different downsampling filter types may be included in data structure 700C (e.g., filter 0712, filter 1714, filter 2716, and filter 3718), and each of the 4 downsampling filter types may be associated with four different sets of interpolation coefficients (respectively shown as coefficient sets 712A-712D, coefficient sets 714A-714D, coefficient sets 716A-716D, and coefficient sets 718A-718D). As described above, each set of the different sets of interpolation coefficients may indicate the level of contribution of each of the pixels adjacent to the downsampling location for generating an interpolated pixel value. In the example shown in FIG. 7C, as there are many out-of-phase downsampling locations between two adjacent pixels, the 4 different sets of interpolation coefficients provide finer control for the level of contribution for the two adjacent pixels than compared to the example shown in FIG. 7B.

Data structure 700D is configured in accordance with first parameter 406 indicating that the maximum possible number of downsampling phases is equal to 8 (e.g., one downsampling phase is in-phase, and the other seven downsampling phases are out-of-phase). In this example, up to 2 different downsampling filter types (filter 1702 and filter 2704) may be included in data structure 700D, and each of the 2 downsampling filter types may be associated with eight different sets of interpolation coefficients (respectively shown as coefficient sets 712A-712H and coefficient sets 714A-714H). As described above, each set of the different sets of interpolation coefficients may indicate the level of contribution of each of the pixels adjacent to the downsampling location for generating an interpolated pixel value. In the example shown in FIG. 7D, as there are more out-of-phase downsampling locations between two adjacent pixels, the 8 different sets of interpolation coefficients provide finer control for the level of contribution for the two adjacent pixels than compared to the example shown in FIG. 7C.

Data structure 700E is configured in accordance with first parameter 406 indicating that the maximum possible number of downsampling phases is equal to 16 (e.g., one downsampling phase is in-phase, and the other 15 downsampling phases are out-of-phase). In this example, just 1 downsampling filter type (e.g. filter 1702) may be included in data structure 700E, which is associated with 16 different sets of interpolation coefficients (shown as coefficient sets 712A-712P). As described above, each set of the different sets of interpolation coefficients may indicate the level of contribution of each of the pixels adjacent to the downsampling location for generating an interpolated pixel value. In the example shown in FIG. 7E, as there are more out-of-phase downsampling locations between two adjacent pixels, the 16 different sets of interpolation coefficients provide finer control for the level of contribution for the two adjacent pixels than compared to the example shown in FIG. 7D.

Each of the downsampling filtering types may be utilized to perform anti-aliasing and/or interpolation. Such filter types include, a Gaussian-based filter, a simple temporal anti-aliasing (STAA)-based filter, a multi-sampling anti-aliasing (MTAA)-based filter, a nearest bicubic-based filter, and/or the like.

FIG. 7F is a diagram of a data structure 700F that includes an identity filter (labelled as “16”), according to some embodiments. Identity filter may be utilized for a region of an image in which no downsampling is performed. The identity filter may include an identity set of coefficients that, when applied to a region of the image, do not downsample the region (e.g., a 1:1 downsampling factor is applied in both the first and second directions). In an example in which 9 coefficients are included in the identity set, the identity set may include the following coefficient values: “0,” “0,” “0,” “0,” “1,” “0,” “0,” “0,” and “0”.

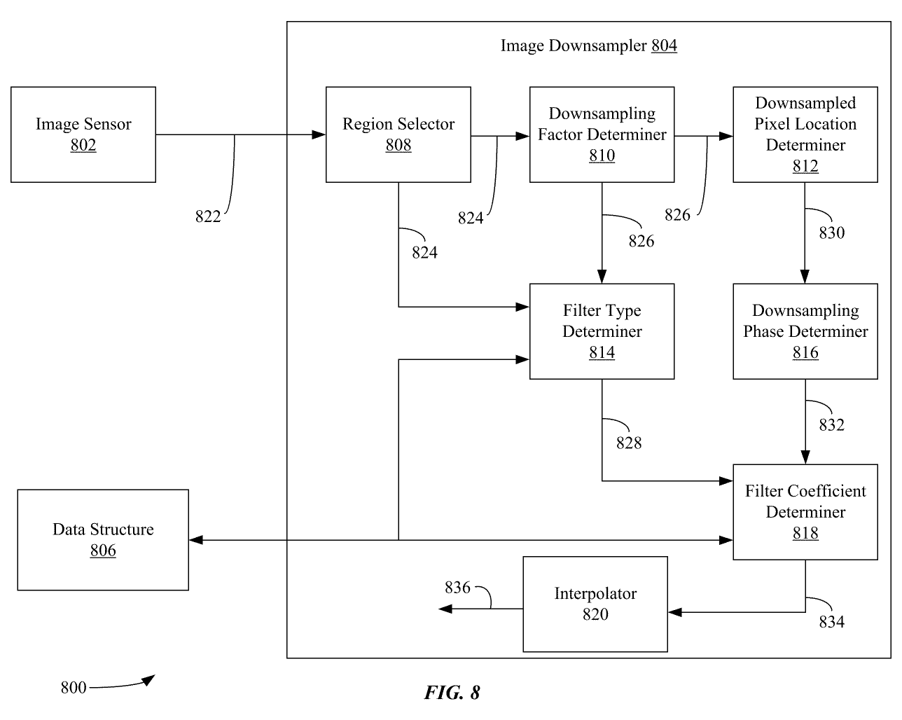

Referring again to FIG. 4, image downsampler 404 may be configured to obtain an image, for example, from image sensor(s) 202, downsample the image on a region-by-region basis, and generate a foveated downampled image. Additional details regarding image downsampler 404 are provided below with reference to FIG. 8.

FIG. 8 is a block diagram of a system 800 for performing foveated downsampling of an image, according to some embodiments. As shown in FIG. 8, system 800 includes an image sensor 802, image downsampler 804, and data structure 806. Image sensor 802 is an example of image sensors 202, image downsampler 804 is an example of image downsampler 404, and data structure 806 is an example of data structures 410, 412, and 700-700E. FIG. 8 will be described with reference to performing foveated downsampling in a first direction (e.g., in the vertical direction). However, it is noted that the operations described with respect to FIG. 8 are also applicable to performing foveated downsampling in a second direction (e.g., in the horizontal direction)

As shown in FIG. 8, image downsampler 804 includes a region selector 808, downsampling factor determiner 810, a downsampled pixel location determiner 812, a filter type determiner 814, a downsampling phase determiner 816, a filter coefficient determiner 818, and an interpolator 820. Each of region selector 808, downsampling factor determiner 810, downsampled pixel location determiner 812, filter type determiner 814, downsampling phase determiner 816, filter coefficient determiner 818, and interpolator 820 may be implemented by processing logic that can include hardware (e.g., circuitry, dedicated logic, programmable logic, and/or microcode), software (e.g., instructions executing on a processing device), or a combination thereof. In some embodiments, each of region selector 808, downsampling factor determiner 810, downsampled pixel location determiner 812, filter type determiner 814, downsampling phase determiner 816, filter coefficient determiner 818, and interpolator 820 is implemented in one or more software processes executing on one or more processor-based computer systems, such as computer system 1200 as described below in reference to FIG. 12.

Region selector 808 may be configured to obtain an image 822 captured by image sensor 802. Region selector 808 may be configured to select a region of image 822 for downsampling. An indication 824 of the selected region may be provided to downsampling factor determiner 810 and filter type determiner 814. The regions of image 500 (e.g., regions [0,0] to [4,4]) depicted in FIG. 5 are examples of regions of image 822.

Downsampling factor determiner 810 may be configured to determine downsampling factors (e.g., a horizontal downsampling factor and a vertical downsampling factor) based on the region indicated by indication 824. The downsampling factor for the region may be predetermined. For instance, the downsampling factor utilized for a particular region and direction may be stored in a configuration register of a device in which image downsampler 804 is included. Example downsampling factors for different regions and directions of image 808 are described above with reference to FIG. 5. Each of the downsampling factors may be stored in a corresponding configuration register. To obtain the downsampling factor for a particular region and direction, downsampling factor determiner 810 may read the configuration register associated with that region and direction. An indication 826 of the determined downsampling factor may be provided to downsampled pixel location determiner 812 and filter type determiner 814.

Filter type determiner 814 may be configured to determine a filter type to be utilized for downsampling based on the region indicated by indication 824. For instance, each of the filter types indicated by data structure 806 may be mapped to a particular region. In an example in which data structure 806 is data structure 700B, filter 1702 may be mapped to a first set of regions (e.g., regions [0,0] to [0,4]), filter 2704 may be mapped to a second set of regions (e.g., regions [1,0] to [1,4]), filter 3706 may be mapped to a third set of regions (e.g., regions [2,0], [2,1], [2,3], and [2,4]), filter 4708 may be mapped to a fourth set of regions (e.g., regions [3,0] to [3,4]), and filter 5710 may be mapped to a fifth set of regions (e.g., regions [4,0] to [4,4]).

A region indicated by indication 824 may correspond to a region in which a user is focused. For instance, in some embodiments in which system 800 is incorporated in a headset, eye-tracking techniques may be utilized to determine a location of image 808 that a user is focused. Indication 824 may indicate whether a particular region (e.g., [2,2] of FIG. 5) is focused on by a user. In response to receiving such an indication, filter type determiner 814 may determine that the filter type is an identity filter. The identity filter may include a set of coefficients that, when applied to a region of image 822, do not downsample the region (e.g., a 1:1 downsampling factor is applied in both the first and second directions). In other words, the downsampling of the region is bypassed to preserve the details of this region of image 822. In such an example, indication 828 may indicate that the determined filter type is the identity filter.

Downsampled pixel location determiner 812 may be configured to determine a downsampled pixel location for pixels in the region indicated by indication 824. For example, referring again to FIG. 6B, the downsampled pixel locations for pixels may either be in between two pixels (e.g., locations 602) or at another pixel (e.g., P4). Downsampled pixel location determiner 812 may provide an indication 830 of the downsampled pixel location for a given pixel. For instance, indication 830 may provide the pixel coordinates for the downsampled pixel location. Indication 830 may be provided to downsampling phase determiner 816.

Downsampling phase determiner 816 may determine the downsampling phase corresponding to the location indicated by indication 830. For instance, referring again to FIG. 6C, a downsampling phase that is in-phase may be represented as a phase value of 0, and a downsampling phase that is out-of-phase (corresponding to locations 602) may be represented as a phase value of 1. In the example shown in FIG. 6C, a downsampling phase corresponding to location 604 may be represented as a phase value of 1, a downsampling phase corresponding to location 606 may be represented as a phase value of 2, and a downsampling phase corresponding to location 608 may be represented as a phase value of 3. Downsampling phase determiner 816 may provide an indication 832 of the determined downsampling phase to filter coefficient determiner 818. Indication 832 may indicate the phase value corresponding to the determined phase.

Filter coefficient determiner 818 may determine the set of filter coefficients to be utilized for downsampling based on the determined filter type indicated by indication 828 and the determined downsampling phase indicated by indication 832. For instance, with reference to FIG. 7B, if indication 828 indicates filter type “0” (e.g., filter 1702) and indication 832 indicates a phase value of 0, then filter coefficient determiner 818 may obtain, from data structure 806 the filter coefficients of set 712A. In another example, if indication 828 indicates filter type “4” (e.g., filter 5710) and indication 832 indicates a phase value of 1, then filter coefficient determiner 818 may obtain, from data structure 806, the filter coefficients of set 720B. In a further example, if indication 828 indicates that the filter type is an identity filter, then filter coefficient determiner 818 may obtain an identity set of coefficients, for example, from data structure 700F. Filter coefficient determiner 818 may provide an indication 834 of the obtained set of filter coefficients to interpolator 820. Each interpolation coefficient in the obtained set of interpolation coefficients (except for the identity set) may be associated with a weight value. A level of contribution of each of the first pixel value and the second pixel value towards the interpolated pixel value is based on the weight value associated with each interpolation coefficient in the obtained set of interpolation coefficients.

Interpolator 820 may generate an interpolated pixel value based on the obtained set of interpolation coefficients indicated by indication 834. The interpolated pixel value may be based on an interpolation of a first pixel value and a second pixel value, where the first pixel value is associated with a first pixel adjacent to the downsampled pixel location, and where the second pixel value is associated with a second pixel adjacent to the downsampled pixel location.

The aforementioned operations may be repeated until pixels of the region identified by indication 824 are downsampled. After downsampling a particular region, region selector 808 may select another region of image 822, and the aformentioned operations may be performed for each newly-selected region until all the regions have been downsampled. The resulting image may be a foveated downsampled image 836. In some embodiments, the downsampling of each region of image 822 may occur in parallel. It is further noted that the aforementioned operations described above with reference to FIG. 8 are performed for both the first and second directions (e.g., the vertical and horizontal directions).

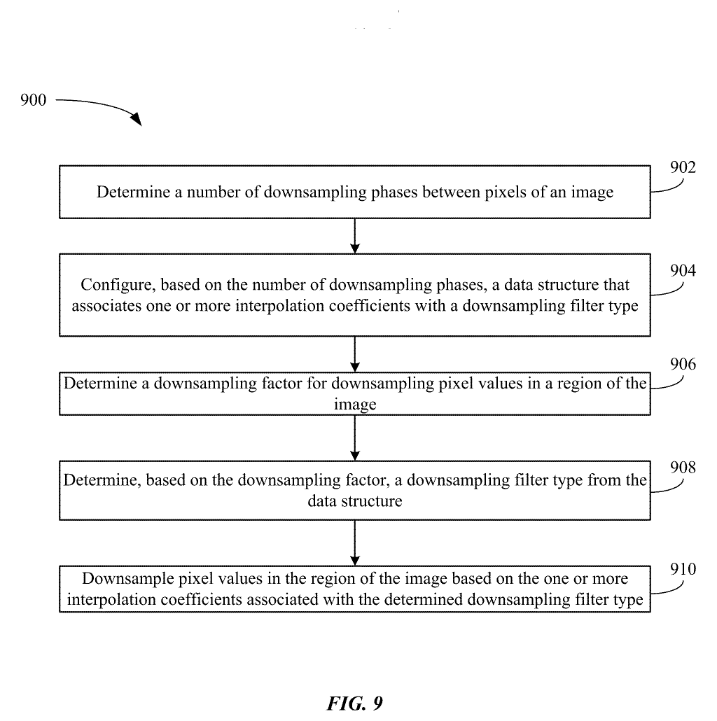

FIG. 9 is a flowchart of a method 900 for performing foveated downsampling of an image, according to some embodiments. Method 900 can be performed by processing logic that can include hardware (e.g., circuitry, dedicated logic, programmable logic, and microcode), software (e.g., instructions executing on a processing device), or a combination thereof. It is to be appreciated that not all operations may be performed simultaneously, or in a different order than shown in FIG. 9, as will be understood by a person of ordinary skill in the art.

Method 900 shall be described with reference to FIGS. 4, 6C, 7C, and 8. Method 900 is not limited to that example embodiment.

In 902, filter coefficient data structure configurer 402 may determine a number of downsampling phases between pixels of an image. For example, filter coefficient data structure configurer 402 may obtain a parameter (e.g., parameter 406 or 408) that indicates a number of downsampling phases that occur between two adjacent pixels of an image during downsampling of the image. For instance, as shown in FIG. 6C (where 1.25:1 downsampling is utilized), the out-of-phase downsampling locations between any two adjacent pixels may be in one of three locations 604, 606, or 608. Every fourth downsampling operation results in an in-phase downsampling location (e.g., P6). In this example, the number of downsampling phases indicated by the parameter is 4 (three out-of-phase locations and one in-phase location).

In 904, filter coefficient data structure configurer 402 may configure, based on the number of downsampling phases, a data structure (e.g., data structure 406 or 408) that associates one or more interpolation coefficients with a downsampling filter type. For example, with reference to FIG. 7C (where the number of downsampling phases is equal to 4), each of the 4 downsampling filter types (e.g., filter 0712, filter 1714, filter 2716, and filter 3718) may be associated with four different sets of interpolation coefficients (respectively shown as coefficient sets 712A-712D, coefficient sets 714A-714D, coefficient sets 716A-716D, and coefficient sets 718A-718D).

In 906, downsampling factor determiner 810 may determine a downsampling factor for downsampling pixel values in a region of the image. For instance, downsampling factor determiner 810 may obtain indication 824 from region selector 808 that indicates a region selected for downsampling. Downsampling factor determiner 810 may determine the downsampling factor based on the region indicated by indication 824.

In 908, filter type determiner 814 may determine, based on the downsampling factor, a downsampling filter type from data structure 806. For instance, filter type determiner 814 may obtain indication 824 from region selector 808 that indicates a region selected for downsampling and may obtain indication 826 of the determined downsampling factor. Filter type determiner 814 may determine the downsampling filter type from data structure 806 based on the region indicated by indication 824 and indication 826 of the determined downsampling factor.

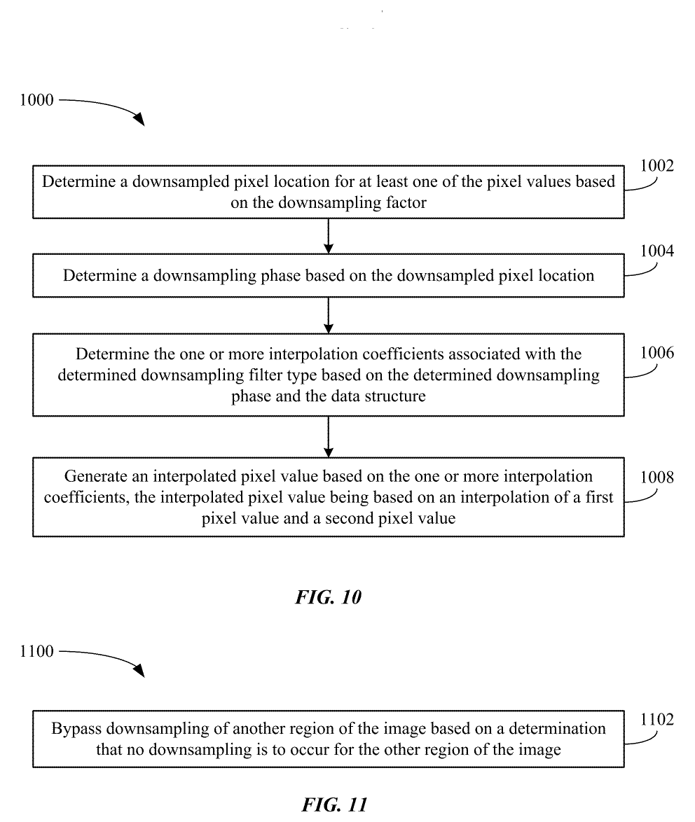

In 910, interpolator 820 may downsample the pixel values in the region of image 822 based on the one or more interpolation coefficients associated with the determined downsampling filter type. Additional details regarding downsampling the pixel values are provided below with reference to FIG. 10.

In some embodiments, each of the downsampling factor, the downsampling filter type, and the one or more interpolation coefficients is associated with at least one of a first downsampling direction (e.g., a vertical direction) or a second downsampling direction that is orthogonal to the first downsampling direction (e.g., a horizontal direction).

FIG. 10 is a flowchart of a method 1000 for downsampling pixel values, according to some embodiments. Method 1000 can be performed by processing logic that can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 10, as will be understood by a person of ordinary skill in the art.

Method 1000 shall be described with reference to FIG. 8. Method 1000 is not limited to that example embodiment.

In 1002, downsampled pixel location determiner 812 may determine a downsampled pixel location for at least one of the pixel values based on the downsampling factor. For instance, downsampled pixel location determiner 812 may obtain indication 826 that indicates the determined downsampling factor and determine the downsampled pixel location based on the downsampling factor indicated by indication 826. Downsampled pixel location determiner 812 may provide an indication 830 of the downsampled pixel location for a given pixel.

In 1004, downsampling phase determiner 816 may determine a downsampling phase based on the downsampled pixel location. For instance, downsampling phase determiner 816 may determine the downsampling phase corresponding to the location indicated by indication 830. Downsampling phase determiner 816 may provide an indication 832 of the determined downsampling phase.

In 1006, filter coefficient determiner 818 may determine the one or more interpolation coefficients associated with the determined downsampling filter type based on the determined downsampling phase and data structure 806. For example, filter coefficient determiner 818 may obtain, from data structure 806, the one or more interpolation coefficients associated with the determined downsampling filter type (e.g., as indicated by indication 828) based on indication 832 of the determined downsampling phase.

In 1008, interpolator 820 may generate an interpolated pixel value based on the one or more interpolation coefficients, the interpolated pixel value being based on an interpolation of a first pixel value and a second pixel value, where the first pixel value is associated with a first pixel adjacent to the downsampled pixel location, and where the second pixel value is associated with a second pixel adjacent to the downsampled pixel location.

In some embodiments, each interpolation coefficient in the one or more interpolation coefficients is associated with a weight value, and a level of contribution of each of the first pixel value and the second pixel value to the interpolated pixel value is based on the weight value associated with each interpolation coefficient in the one or more interpolation coefficients.

As described above, the downsampling of certain regions may be bypassed. FIG. 11 is a flowchart of a method 1100 for bypassing downsampling of a region of an image, according to some embodiments. Method 1100 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 11, as will be understood by a person of ordinary skill in the art.

Method 1100 shall be described with reference to FIG. 8. Method 1100 is not limited to that example embodiment.

In 1102, interpolator 820 may bypass downsampling of another region of image 822 based on a determination that no downsampling is to occur for the other region of image 822. For example, filter type determiner 814 may determine that no downsampling is to occur for the other region of image 822. For instance, filter type determiner 814 may determine that a downsampling factor for the other region of the image is a 1:1 downsampling factor (e.g., based on indication 826). In some embodiments, to bypass downsampling of the other region of the image, interpolator 820 may apply an identity filter to pixels of the other region.

Various aspects can be implemented, for example, using one or more computer systems, such as computer system 1200 shown in FIG. 12. Computer system 1200 can be any computer capable of performing the functions described herein, such as the functions of device 100 of FIGS. 1 and 2, image signal processor 206 of FIG. 3, foveated downsampler 318 (and the components thereof), as respectively described with reference to FIGS. 4-8, and the operations of FIGS. 9-11. Computer system 1200 includes one or more processors (also called central processing units, or CPUs), such as a processor 1204. Processor 1204 is connected to a communication infrastructure 1206 (e.g., a bus). Computer system 1200 also includes user input/output device(s) 1203, such as monitors, keyboards, and pointing devices, that communicate with communication infrastructure 1206 through user input/output interface(s) 1202. Computer system 1200 also includes a main or primary memory 1208, such as random access memory (RAM). Main memory 1208 may include one or more levels of cache. Main memory 1208 has stored therein control logic (e.g., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 includes a computer usable or readable storage device having stored thereon computer software (control logic) and/or data. Removable storage unit 1218 may be a floppy disk, magnetic tape, compact disk, DVD, optical storage disk, and/or any other computer data storage device. Removable storage drive 1214 reads from and/or writes to removable storage unit 1218 in a well-known manner.

According to some aspects, secondary memory 1210 may include other means, instrumentalities or other approaches for allowing computer programs and/or other instructions and/or data to be accessed by computer system 1200. Such means, instrumentalities or other approaches may include, for example, a removable storage unit 1222 and an interface 1220. Examples of the removable storage unit 1222 and the interface 1220 may include a program cartridge and cartridge interface (e.g., such as that found in video game devices), a removable memory chip (e.g., an EPROM or PROM) and associated socket, a memory stick and USB port, a memory card and associated memory card slot, and/or any other removable storage unit and associated interface.

Computer system 1200 may further include a communication or network interface 1224. Communication interface 1224 enables computer system 1200 to communicate and interact with any combination of remote devices, remote networks, remote entities, etc. (individually and collectively referenced by reference number 1228). For example, communication interface 1224 may allow computer system 1200 to communicate with remote devices 1228 over communications path 1226, which may be wired and/or wireless, and which may include any combination of LANs, WANs, the Internet, etc. Control logic and/or data may be transmitted to and from computer system 1200 via communication path 1226.

Image capture device(s) 1230 may include one or more camera units configured to capture images, e.g., images which may be processed to generate enhanced versions of the captured images, e.g., based on this disclosure. Image capture device(s) 1230 may include one or more lens assemblies 1234, where each lens assembly has a separate focal length. For example, one lens assembly may have a shorter focal length relative to the focal length of another lens assembly. Each of lens assembly(ies) 1234 may have a separate associated sensor element (e.g., sensor element(s) 1232). Alternatively, lens assembly(ies) 1234 may share common sensor element(s) 1232. Sensor element(s) 1232 may include image sensor(s) configured to convert light waves into electrical signals representing an image. Image capture device(s) 1230 may capture still and/or video images. Output from image capture device(s) 1230 may be processed, at least in part, by processor 1204 and/or a dedicated image processing unit or image signal processor 1236 incorporated within image capture device(s) 1230. Image signal processor 1236 may be configured to process captured images based on any suitable image processing algorithm. For example, image signal processor 1236 can process raw data that represents the captured images into a suitable file format, such as Y’UV, YUV, YCbCr, YPbPr, or any other file format. As another example, image signal processor 1236 may perform automatic white balance (AWB) and may resize images as needed. As an option, image signal processor 1236 may be configured to compress the images into a suitable format by employing any available compression standard, such as JPEG or MPEG and their associated variants. Foveated downsampler 318 may be implemented via image signal processor 1236 and/or processor 1204. Captured images may be stored in main memory 1208 and/or secondary memory 1210.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1200, main memory 1208, secondary memory 1210 and removable storage units 1218 and 1222, as well as tangible articles of manufacture embodying any combination of the foregoing. Such control logic, when executed by one or more data processing devices (e.g., computer system 1200), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 12. In particular, aspects may operate with software, hardware, and/or operating system implementations other than those described herein.

It is to be appreciated that the Detailed Description section, and not the Abstract of the Disclosure section, is intended to be used to interpret the claims. The Abstract of the Disclosure section may set forth one or more but not all possible aspects of the present disclosure as contemplated by the inventor(s), and thus, are not intended to limit the subjoined claims in any way.

Unless stated otherwise, the specific aspects are not intended to limit the scope of claims that are drafted based on this disclosure to the disclosed forms, even where only a single example is described with respect to a particular feature. The disclosed aspects are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several aspects so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the aspects introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
determining a number of downsampling phases between pixels of an image;
configuring, based on the number of downsampling phases, a data structure that associates one or more interpolation coefficients with a downsampling filter type;
determining a downsampling factor for downsampling pixel values in a region of the image; determining, based on the downsampling factor, a downsampling filter type from the data structure; and
downsampling pixel values in the region of the image based on the one or more interpolation coefficients associated with the determined downsampling filter type.

2. The method of claim 1, wherein downsampling the pixel values comprises:
determining a downsampled pixel location for at least one of the pixel values based on the downsampling factor;
determining a downsampling phase based on the downsampled pixel location;
determining the one or more interpolation coefficients associated with the determined downsampling filter type based on the determined downsampling phase and the data structure; and
generating an interpolated pixel value based on the one or more interpolation coefficients, the interpolated pixel value being based on an interpolation of a first pixel value and a second pixel value, wherein the first pixel value is associated with a first pixel adjacent to the downsampled pixel location, and wherein the second pixel value is associated with a second pixel adjacent to the downsampled pixel location.

3. The method of claim 2, wherein each interpolation coefficient in the one or more interpolation coefficients is associated with a weight value, and wherein a level of contribution of each of the first pixel value and the second pixel value to the interpolated pixel value is based on the weight value associated with each interpolation coefficient in the one or more interpolation coefficients.

4. The method of claim 1, further comprising:
bypassing downsampling of another region of the image based on a determination that no downsampling is to occur for the other region of the image.

5. The method of claim 4, wherein bypassing downsampling the other region of the image comprises:
determining that a downsampling factor for the other region of the image is a 1-1. downsampling factor.

6. The method of claim 4, wherein bypassing downsampling of the other region of the image comprises:
applying an identity filter to pixel values of the other region.

7. The method of claim 1, wherein each of the downsampling factor, the downsampling filter type, and the one or more interpolation coefficients is associated with a first downsampling direction or a second downsampling direction that is orthogonal to the first downsampling direction.

8. A system, comprising:
a memory; and
at least one processor configured to:
determine a number of downsampling phases between pixels of an image;
configure, based on the number of downsampling phases, a data structure that associates one or more interpolation coefficients with a downsampling filter type;
determine a downsampling factor for downsampling pixel values in a region of the image;
determine, based on the downsampling factor, a downsampling filter type from the data structure; and
downsample pixel values in the region of the image based on the one or more interpolation coefficients associated with the determined downsampling filter type.

9. The system of claim 8, wherein, to downsample the pixel values, the at least one processor is configured to:
determine a downsampled pixel location for at least one of the pixel values based on the downsampling factor;
determine a downsampling phase based on the downsampled pixel location;
determine the one or more interpolation coefficients associated with the determined downsampling filter type based on the determined downsampling phase and the data structure; and
generate an interpolated pixel value based on the one or more interpolation coefficients, the interpolated pixel value being based on an interpolation of a first pixel value and a second pixel value, wherein the first pixel value is associated with a first pixel adjacent to the downsampled pixel location, and wherein the second pixel value is associated with a second pixel adjacent to the downsampled pixel location.

10. The system of claim 9, wherein each interpolation coefficient in the one or more interpolation coefficients is associated with a weight value, and wherein a level of contribution of each of the first pixel value and the second pixel value to the interpolated pixel value is based on the weight value associated with each interpolation coefficient in the one or more interpolation coefficients.

11. The system of claim 8, wherein the at least one processor is further configured to:
bypass downsampling of another region of the image based on a determination that no downsampling is to occur for the other region of the image.

12. The system of claim 11, wherein, to bypass downsampling the other region of the image, the at least one processor is configured to:
determine that a downsampling factor for the other region of the image is a 1-1. downsampling factor.

13. The system of claim 11, wherein, to bypass downsampling of the other region of the image, the at least one processor is configured to:
apply an identity filter to pixel values of the other region.

14. The system of claim 8, wherein each of the downsampling factor, the downsampling filter type, and the one or more interpolation coefficients is associated with at least one of a first downsampling direction or a second downsampling direction that is orthogonal to the first downsampling direction.

15. A non-transitory computer readable medium having instructions stored thereon that, when executed by at least one processor, cause the at least one processor to perform operations comprising:
determining a number of downsampling phases between pixels of an image;
configuring, based on the number of downsampling phases, a data structure that associates one or more interpolation coefficients with a downsampling filter type;
determining a downsampling factor for downsampling pixel values in a region of the image; determining, based on the downsampling factor, a downsampling filter type from the data structure; and
downsampling pixel values in the region of the image based on the one or more interpolation coefficients associated with the determined downsampling filter type.

16. The non-transitory computer readable medium of claim 15, wherein downsampling the pixel values comprises:
determining a downsampled pixel location for at least one of the pixel values based on the downsampling factor;
determining a downsampling phase based on the downsampled pixel location;
determining the one or more interpolation coefficients associated with the determined downsampling filter type based on the determined downsampling phase and the data structure; and
generating an interpolated pixel value based on the one or more interpolation coefficients, the interpolated pixel value being based on an interpolation of a first pixel value and a second pixel value, wherein the first pixel value is associated with a first pixel adjacent to the downsampled pixel location, and wherein the second pixel value is associated with a second pixel adjacent to the downsampled pixel location.

17. The non-transitory computer readable medium of claim 16, wherein each interpolation coefficient in the one or more interpolation coefficients is associated with a weight value, and wherein a level of contribution of each of the first pixel value and the second pixel value to the interpolated pixel value is based on the weight value associated with each interpolation coefficient in the one or more interpolation coefficients.

18. The non-transitory computer readable medium of claim 15, the operations further comprising:
bypassing downsampling of another region of the image based on a determination that no downsampling is to occur for the other region of the image.

19. The non-transitory computer readable medium of claim 18, wherein bypassing downsampling the other region of the image comprises:
determining that a downsampling factor for the other region of the image is a 1-1. downsampling factor.

20. The non-transitory computer readable medium of claim 18, bypassing downsampling the other region of the image comprises:
applying an identity filter to pixel values of the other region.
